(19) United States
(12) Patent Application Publication
(10) Pub. No.: US 2008/0100040 A1
(43) Pub. Date: May 1, 2008

(54) Airbag cover retention method

(75) Inventors: Timothy A. DePottey, Flint, MI (US); Ken Pijaszek, Grand Blanc, MI (US); Matt Reschke, Royal Oak, MI (US)

Correspondence Address: Sally J. Brown;AUTOLIV ASP, INC., 3350 Airport Road, Ogden, UT, 84405, US

(73) Assignee: Autoliv ASP, Inc.

(21) Appl. No.: 11/588,706

(22) Filed: Oct. 27, 2006

(51) Int. Cl. B60R 21/217; B60R 21/215; B60R 21/203

(52) U.S. Cl. 280/728.2; 280/728.3; 280/731

(57) ABSTRACT

This invention is a new type of airbag apparatus that includes an airbag cover. The airbag cover is designed to match the décor of the vehicle and to prevent the occupant from viewing the undeployed airbag system. The airbag cover has a front panel and a plurality of legs. The plurality of legs that extend rearward of a front panel. An airbag retainer is also added to the apparatus. The retainer has a plurality of slots and is designed such that each leg is oriented to pass through a separate slot. The airbag apparatus also includes a retention plate attached to the retainer. Each of the legs includes a first ear and a second ear. The first ear overlaps and provides resistive engagement with the retainer to prevent the cover from separating during deployment. Similarly, the second ear overlaps and provides resistive engagement with the retention plate to resist separation of the cover during deployment.

### BACKGROUND OF THE INVENTION

Inflatable safety restraint devices, or “airbag restraints,” are mandatory on most new vehicles. Airbag restraints commonly contain a collision sensor, an inflator, and an inflatable airbag. In the event of an accident, the collision sensor within the vehicle, such as an accelerometer, measures abnormal deceleration and triggers the inflator. The inflator is connected to the one or more airbags positioned within the vehicle. Upon receipt of the signal from the collision sensor, the inflator rapidly produces a quantity of inflation fluid or gas, which fills the airbag and protects the passenger from harmful impact with the interior of the vehicle.

Although airbag systems greatly enhance the overall safety of a vehicle, these systems are often visually unappealing and do not match other portions of the vehicle's décor. Accordingly, vehicle manufactures have developed airbag covers that enclose the airbag system to prevent the airbag system from being viewed by the occupant. In general, these covers are positioned on the vehicle's steering wheel, dashboard, and/or other locations in the vehicle having an installed airbag. These covers are typically made of a thermoplastic material and will generally will correspond to other portions of the décor of the vehicle. During deployment of the airbag, all or a portion of the cover will open to allow the deploying airbag to become positioned in the proper position on the interior of the vehicle. Thus, by positioning an airbag cover to enclose the airbag system, the vehicle occupant will still enjoy the benefits of the airbag system, but at the same time, will have a vehicle interior that is visually appealing.

As is recognized by those skilled in the art, it is necessary to secure the airbag cover to the vehicle to ensure that the deployment of the airbag does not separate the airbag cover from the vehicle. The reason for securing the cover to the vehicle is self-evident: if the airbag cover did, in fact, separate from the vehicle during deployment, the forces associated with deployment could propel the cover into the vehicle interior towards the vehicle occupant.

Airbag and vehicle manufacturers go to great lengths to ensure that the airbag cover does not separate from the vehicle during deployment. In some prior art systems, this may involve attaching, via rivets, etc., the airbag cover to another portion of the airbag system (such as the airbag container).

Another prior art system for securing the airbag cover to the airbag system is disclosed in U.S. Pat. No. 5,354,093 (which patent is incorporated herein by reference and is referred to as the “'093 patent”). The '093 patent attaches the airbag cover through a plurality of “latch hooks” that engage one or more “latch surfaces” on the airbag system. The latch hooks hold and retain the airbag cover during deployment of the airbag. By using these latch hooks, the '093 patent operates to attach the airbag cover without the need for rivets or other fasteners. Accordingly, the '093 patent teaches a means for attaching the airbag cover to the airbag system that is simple and inexpensive to use.

Although the means for attaching an airbag cover taught in the '093 patent has its advantages, this attachment system may not provide sufficient retention of the airbag cover during a severe, violent crash. The reason for this is that the engagement between the latch hooks and the latch surfaces may, in some situations, lack the strength necessary to withstand the strong forces associated with a violent vehicle crash. Accordingly, a new apparatus for attaching an airbag cover to a vehicle is needed. This new attachment mechanism will be, like the '093 patent, easy to use, yet at the same time, will operate to secure the airbag cover to the airbag system during crashes. Such a new system/apparatus is disclosed herein.

### BRIEF SUMMARY OF THE INVENTION

The present embodiments constitute a new type of airbag apparatus. This apparatus includes an airbag cover. The airbag cover is designed such that it will enclose the airbag system to prevent the vehicle occupant from viewing the undeployed airbag/airbag system. The airbag cover is generally made to match/correspond with the décor of the vehicle interior.

The cover includes a front panel that will be positioned over the airbag when installed in a vehicle. The front panel includes one or more doors through which the airbag will deploy in the event of an accident or crash. The cover also includes a plurality of legs that extend rearward of the front panel. Each of the legs comprises a first ear and a second ear.

The airbag apparatus also includes a retainer that engages the cover. The retainer includes a plurality of slots. Each of the legs of the cover are designed to pass through a separate slot. As is known in the art, the retainer is designed to retain and hold the airbag. More specifically, the airbag will be positioned between the front panel and the retainer. In general, the airbag will be secured to the retainer via fasteners, screws, etc.

The airbag apparatus may further comprise a strand that encircles all or a portion of an airbag inflator. The strand includes one or more loops that extend rearward of the retainer. In general, the loops are designed such that they may engage other portions of the steering column, armature, or other portions of the vehicle structure as a means of securing/attaching the airbag apparatus to the vehicle.

A retention plate is also included as part of the airbag apparatus. The retention plate is positioned behind the retainer and will be attached to the retainer via fasteners. Openings may also be added to the retention plate. One particular example of the openings that may be added is an inflator opening added to the retention plate and sized such that a portion of the inflator may extend through the retention plate.

As noted above, the cover includes legs, each with a first ear and a second ear. The first ear and the second ear are hooks, detents, dogs, barbs, overhangs, or other features that can engage another surface. The first ear engages a surface of the retainer. The engagement between the first ear and the retainer is “resistive engagement” as it prevents the cover from separating from other portions of the airbag apparatus during deployment.

The second ear of the cover is designed to engage the retention plate. The second ear overlaps and engages a lip on the retention plate. Again, the engagement between the second ear and the retention plate is “resistive engagement” in that it prevents the cover from separating from other portions of the airbag apparatus during deployment.

In further embodiments, the legs may comprise a cleft that is positioned proximate (such as beneath) the second ear. An engaging portion is also added to the retention plate. These embodiments are constructed such that the engaging portion of the retention plate may be inserted into the cleft. Other embodiments may further allow the engaging portion to engage the cleft by having a portion of the engaging portion be coined (shaved) down to provide greater interaction between these two features.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of an airbag cover that may be used as part of the present embodiments;

FIG. 2 is a perspective view of an airbag apparatus of the present embodiments that includes the airbag cover of FIG. 1;

FIG. 3 is a perspective view of the airbag apparatus of FIG. 2 in which a retention plate has been added; and

FIG. 4 is a cross-sectional view that illustrates the engagement between the airbag cover and the retention plate.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

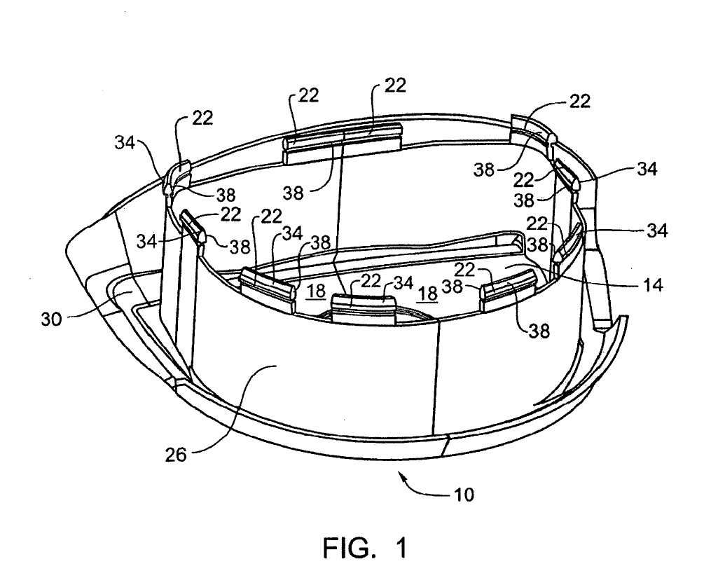

Referring now to FIG. 1, a perspective view illustrates an airbag cover 10 that may be used in the present embodiments. More specifically, the airbag cover 10 may be used as part of an airbag apparatus in accordance with the present embodiments. The airbag cover 10 is generally made of a plastic material (such as a molded thermoplastic) and is constructed to match/correspond with the décor of the vehicle interior. As shown in FIG. 1, the cover 10 is designed for use as part of a driver's airbag module; accordingly, the cover 10 is designed for use with a steering wheel (not shown), and more particularly, designed for use with a center hub of a steering wheel. Steering wheels have a variety of different shapes and sizes that may be used. In other embodiment, the airbag cover 10 may be designed for use with a passenger (dashboard) airbag, or any other type of vehicle airbag.

Like other types of airbag covers, the cover 10 is designed such that it will enclose the airbag system to prevent the vehicle occupant from viewing the undeployed airbag/airbag system. Accordingly, the cover 10 includes a front panel 14 that will be positioned over the airbag when installed in a vehicle. The front panel 14 includes one or more doors 18 through which the airbag will deploy in the event of an accident or crash. When a crash occurs, the airbag will inflate and move through the doors 18 so that it can be positioned on the interior of the vehicle in an inflated configuration that prevents the vehicle occupant from harmfully impacting a vehicle surface, the steering wheel, etc.

The cover 10 includes a plurality of legs 22 that extend rearward of the front panel 14. An extension 26 may be used to correct the legs 22 to the front panel 14. In other embodiments, the legs 22 may be connected directly to the front panel 14. Other trim feature(s) 30 may be added to more appropriately match the cover 10 to the steering wheel.

Each of the legs 22 comprises a first ear 34 and a second ear 38. As will be described in greater detail below, the first ear 34 is designed to overlap and engage a retainer (not shown in FIG. 1) whereas the second ear 38 is designed to overlap and engage a retention plate (not shown in FIG. 1).

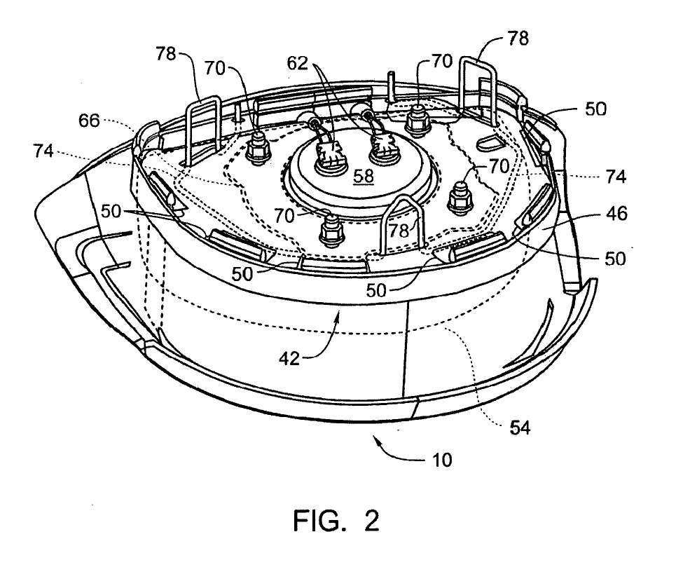

Referring now to FIG. 2, a perspective view illustrates the cover 10 used as part of an airbag apparatus 42 according to the present embodiments. This airbag apparatus includes a retainer 46. The retainer 46 is a feature made of metal, plastic, or any other suitable material and is designed to engage the cover 10. As shown in FIG. 2, the retainer 46 includes a plurality of slots 50. Each of the legs 22 of the cover 10 are designed to pass through a separate slot 50. Thus, the position, size, and orientation of the slots 50 will be made to allow one of the legs 22 to pass through a slot 50.

As is known in the art, the retainer 46 is designed to retain and hold the airbag 54 (shown in phantom lines). More specifically, the airbag 54 will be positioned between the front panel 14 and the retainer 46. In general, the airbag 54 will be secured to the retainer 46 via fasteners, screws, etc. Of course, the exact manner in which the airbag 54 may be oriented and attached to the retainer 46/airbag apparatus 42 is known in the art. A particular example of the way in which the airbag 54 may be attached is found in the '093 patent. A retainer ring (not shown) may also be used with the airbag 54 as a means of further securing the airbag 54.

An inflator 58 may also be used as parts of the airbag assembly 42. As is known in the art, the inflator 58 is a device that is capable of producing and/or channeling a volume of inflation gas into the airbag 54 in the event of an accident. Such an influx of inflation gas into the airbag 54 inflates and deploys the airbag 54 through the doors 18 (not shown in FIG. 2) so that the airbag 54 can protect a vehicle occupant. The inflator 58 is of the type known in the art. One or more initiation wires 62 are also added to the inflator 58. These wires 62 receive the signal that the vehicle is experiencing a crash. More specifically, if a crash is experienced, an electrical signal will be transmitted to the inflator 58 via the wires 62 and will cause the inflator 58 to activate and produce inflation gas sufficient to inflate the airbag 54.

As shown in FIG. 2, the inflator 58 comprises an attachment plate 66 that is designed to connect the inflator 58 to the retainer 46 and other portions of the airbag apparatus 42. Specifically, the plate 66 has been welded, formed, or otherwise added to the inflator 58. The plate 66 may be connected to the retainer 46 via fasteners 70.

The airbag apparatus 42 may further comprise a strand 74 that encircles all or a portion of the inflator 58. The strand 74 includes one or more loops 78 that extend rearward of the retainer 46. In general, the loops 78 are designed such that they may engage other portions of the steering column, armature, or other portions of the vehicle structure as a means for securing/attaching the airbag apparatus 42 to the vehicle.

Referring still to FIG. 2, embodiments may be constructed such that the legs 22 snap outwardly after they have been passed through the slots 50. This means that in order for the legs 22 to separate from the slots 50, the legs 22 must be compressed inward. However, when the airbag 54 deploys, it will generally push outwardly on the legs 22, and thus will prevent the legs 22 from disengaging from the slots 50.

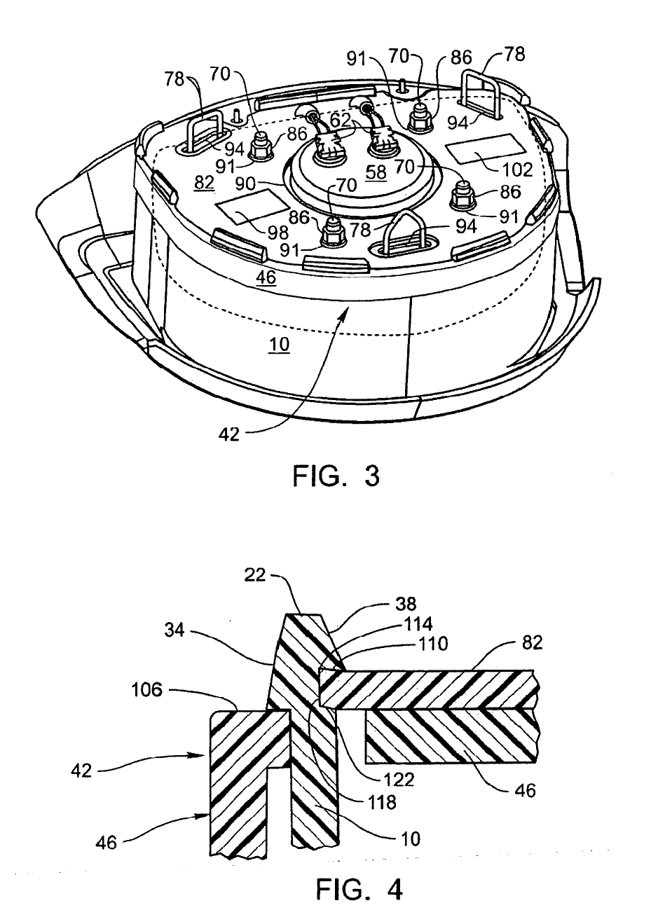

Referring now to FIG. 3, a perspective view illustrates a further aspect of the airbag apparatus 42 of the present embodiments. As shown in FIG. 3, a retention plate 82 is also included as part of the airbag apparatus 42. The retention plate 82 is positioned behind the retainer 46 and will be attached to the retainer 46 via the fasteners 70. Nuts 86 may also be added to hold the fasteners 70 in the proper position. The retention plate 82 may be made of metal, plastic, or other suitable materials.

Openings may also be added to the retention plate 82. For example, an inflator opening 90 is added to the retention plate 82 and is sized such that a portion of the inflator 58 may extend through the retention plate 82. Holes 91 that receive the fasteners 70 may also be added to the retention plate 82. Further embodiments, including the embodiment shown in FIG. 3, have loop openings 94 that allow the loops 78 to extend rearward and engage a portion of the vehicle structure.

In addition to the loops 78, one or more additional attachment features 98 may be added to the retention plate 82. (These attachment features 98 are represented graphically as a box in FIG. 3.) In some embodiments, the attachment feature may comprise fasteners, pins, and/or any other feature that is capable of engaging/connecting the airbag apparatus 42 to the armature or other vehicle structure.

As can be seen in FIG. 3, embodiments may be made in which a horn attachment feature 102 is added to the retention plate 82. More than one horn attachment feature 102 may also be used. In FIG. 3, the horn attachment feature 102 is represented graphically as a box. The horn attachment feature 102 is any feature or structure that may be used to attach or connect to a vehicle horn (or horn system). The horn feature 102 may be molded directly into the retention plate 82. However, other embodiments may be constructed in which the horn feature 102 is a separate feature that has been attached to the retention plate 82 via welding, fasteners, etc. In other embodiments, the entirety of the horn system is added directly to the retention plate 82.

Referring now to FIG. 4, a cross-sectional view illustrates the way in which the airbag apparatus 42 operates to retain the airbag cover 10 during a crash and/or during deployment of the airbag 54. Specifically, FIG. 4 is a cross-sectional view that shows the engagement between the cover 10 and the retainer 46 as well as the engagement between the cover 10 and the retention plate 82.

As described above, the cover 10 includes a first ear 34 and a second ear 38. The first ear 34 is a hook, detent, or other feature that overlaps and engages a surface of the retainer 46. Preferably, the first ear 34 overlaps and engages a top surface 106 of the retainer 46. The engagement between the first ear 34 and the retainer 46 is “resistive engagement” as it prevents the cover 10 from separating from other portions of the airbag apparatus 42 during deployment. When the airbag 54 is deployed through the doors 18 (not shown in FIG. 4), the force of the deploying airbag will push the cover 10 towards the vehicle interior. However, the resistive engagement between the first ear 34 and the retainer 46 retains the cover 10 and prevents the forces associated with deployment from separating the cover 10 separate from other portions of the airbag apparatus 42.

The second ear 38 of the cover 10 is designed to engage the retention plate 82. The second ear 38 is a hook, detent, or other feature that overlaps and engages a surface of the retention plate 82. More specifically, the second car 38 overlaps and engages a lip 110 on the retention plate 82. In further embodiments, the second ear 38 will overlap and capture all or a portion of the lip 110. Again, the engagement between the second ear 38 and the retention plate 82 is “resistive engagement” in that it prevents the cover 10 from separating from other portions of the airbag apparatus 42 during deployment.

As shown in FIG. 4, the legs 22 may further comprise a cleft 114 that is positioned proximate (such as beneath) the second ear 38. An engaging portion 118 is also added to the retention plate 82. The engaging portion 118 may be an end of the plate 82, or, in other embodiments, may be an external feature that is added to the plate 82. As can be seen in FIG. 4, the airbag apparatus 42 may be designed such that an engaging portion 1118 of the retention plate 82 may be inserted into the cleft 114.

Referring still to FIG. 4, a corner 122 (or other section) of the engaging portion 118 has been coined or shaved to provide further engagement with the cleft 114. In some embodiments, such coining provides a small radius (which may allow clearance over the retainer 46) into which the engaging portion 118 may snugly engage the cleft 114 and provide greater interaction between these two features. As shown in FIG. 4, the bottom corner 122 has been coined whereas the top corner or other corners/portions have not been coined/shaved off. However, in other embodiments, such other portions of the engaging portion 118 may be coined, depending upon the specifications of the manufacturer.

Referring now to FIGS. 1-4 generally, it will be appreciated that the present airbag apparatus 42 also provides a method for retaining an airbag cover 10 during deployment of the airbag 54. This method may be practiced by obtaining an airbag cover 10 (having the legs 22) and obtaining a retainer 46 with the slots 50. Each of the legs 22 will then be passed through a separate slot 50. Finally, the retention plate 82 will be attached to the airbag apparatus 42. Such attachment of the retention plate 82 will allow the first ear 34 to overlap and provide resistive engagement with the retainer 46 to prevent the cover 10 from separating during deployment. This attaching of the retention plate 82 also allows the second ear 38 to overlap the retention plate 82 and provides resistive engagement to resist separation of the cover 10 during deployment.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An airbag apparatus comprising:
an airbag cover having a plurality of legs that extend rearward of a front panel, wherein each of the legs comprise a first ear and a second ear;
a retainer having a plurality of slots, wherein each leg is oriented to pass through a separate slot; and
a retention plate attached to the retainer,
wherein the first ear overlaps and provides resistive engagement with the retainer to prevent the cover from separating during deployment and the second ear overlaps and provides resistive engagement with the retention plate to resist separation of the cover during deployment.

2. An airbag apparatus as in claim 1 wherein each of the legs further comprise a cleft for receiving which an engaging portion of the retention plate.

3. An airbag apparatus as in claim 2 wherein a corner of the engaging portion has been coined to provide further engagement with the cleft.

4. An airbag apparatus as in claim 1 wherein the retention plate comprises a lip and wherein the second ear overlaps and captures the lip.

5. An airbag apparatus as in claim 1 wherein the legs snap outwardly after they have been passed through the slots.

6. An airbag apparatus as in claim 1 wherein the retention plate further comprises a horn feature.

7. An airbag apparatus as in claim 1 wherein the retention plate further comprises an attachment feature.

8. An airbag apparatus as in claim 1 wherein the retention plate comprises an opening to receive an inflator.

9. An airbag apparatus comprising:
an airbag cover having a plurality of legs that extend rearward of a front panel, wherein each of the legs comprise a first ear and a second ear and wherein each of the legs further comprise a cleft into which an engaging portion of the retention plate is inserted;
a retainer having a plurality of slots, wherein each leg is oriented to pass through a separate slot, and
a retention plate comprises a lip, wherein the retention plate is attached to the retainer;
wherein the first ear overlaps and provides resistive engagement with the retainer to prevent the cover from separating during deployment and the second ear overlaps and provides resistive engagement with the lip to resist separation of the cover during deployment.

10. An airbag apparatus as in claim 9 wherein a corner of the engaging portion has been coined to provide further engagement with the cleft.

11. An airbag apparatus as in claim 10 wherein the retention plate further comprises a horn feature.

12. An airbag apparatus as in claim 11 wherein the retention plate further comprises an attachment feature.

13. A method for retaining an airbag cover during deployment comprising:
obtaining an airbag cover having a plurality of legs that extend rearward of a front panel, wherein each of the legs have a first ear and a second ear;
obtaining a retainer having a plurality of slots;
passing each of the legs through a separate slot;
attaching a retention plate such that the first ear overlaps and provides resistive engagement with the retainer to prevent the cover from separating during deployment and the second ear overlaps and provides resistive engagement with the retention plate to resist separation of the cover during deployment.
